(19) United States
(12) Patent Application Publication
(10) Pub. No.: US 2015/0090507 A1
(43) Pub. Date: Apr. 2, 2015

(54) MOTOR DRIVING DEVICE FOR FORKLIFTS AND FORKLIFT USING SAME

(71) Applicant: Sumitomo Heavy Industries, Ltd., Tokyo (JP)

(72) Inventors: Junichi Okada, Kanagawa (JP); Takumi Itoh, Kanagawa (JP); Kohei Kubo, Kanagawa (JP)

(21) Appl. No.: 14/567,603

(22) Filed: Dec. 11, 2014

Related U.S. Application Data
(63) Continuation of application No. PCT/JP2013/003769, filed on Jun. 17, 2013.

(30) Foreign Application Priority Data
Jun. 19, 2012 (JP) 2012-138068

(51) Int. Cl. B66F 9/075

(52) U.S. Cl. CPC B66F 9/07572
USPC 180/65.51; 701/50

(57) ABSTRACT

A motor drive apparatus, mounted to a forklift and controlling at least one motor configured to rotate a drive wheel of the forklift, based on a speed command value indicative of a target speed of the forklift, includes a turn speed limit unit in which a speed limit curve configured to stipulate an upper limit value of a speed of the forklift is defined as a function of a turning angle of the forklift such that an angular velocity with respect to a center of rotation of the forklift does not exceed a threshold value, the turn speed limit unit being configured to limit the speed command value to be equal to or less than an upper limit value determined according to the speed limit curve and the turning angle, and a drive unit configured to drive the at least one motor according to the speed command value.

### RELATED APPLICATIONS

Priority is claimed to Japanese Patent Application No. 2012-138068, filed Jun. 19, 2012, and International Patent Application No. PCT/JP2013/003769, the entire content of each of which is incorporated herein by reference.

### BACKGROUND

1. Technical Field

Certain embodiments of the present invention relate to a traveling motor drive apparatus for forklifts.

2. Description of Related Art

An electric forklift using a battery as a power source is a type of industrial vehicle. The electric forklift (hereinafter, simply referred to as “a forklift”) includes a traveling motor which transfers power to front wheels as traveling wheels (drive wheels), a hydraulic actuator motor (a steering motor) which transfers power to a hydraulic pump for controlling turning angles (steering angles) of rear wheels as turning wheels, a hydraulic actuator motor (a cargo handling motor) which transfers power to a hydraulic pump for controlling a lifting body, and an electric power converter which drives each of the traveling motor, the steering motor, and the cargo handling motor.

### SUMMARY

According to an embodiment of the present invention, there is provided a motor drive apparatus mounted to a forklift and controlling at least one motor configured to rotate a drive wheel of the forklift, based on a speed command value indicative of a target speed of the forklift. The motor drive apparatus includes a turn speed limit unit in which a speed limit curve configured to stipulate an upper limit value of a speed of the forklift is defined as a function of a turning angle of the forklift such that an angular velocity (referred to as “a yaw rate” in the specification) with respect to a center of rotation of the forklift does not exceed a threshold value, the turn speed limit unit being configured to limit the speed command value to be equal to or less than an upper limit value determined according to the speed limit curve and the turning angle, and a drive unit configured to drive the at least one motor according to the speed command value output from the turning speed limit unit.

According to another embodiment of the present invention, there is provided a forklift. The forklift includes left and right drive wheels, left and right traveling motors configured to transfer power to the respective left and right drive wheels, and the above-mentioned motor drive apparatus configured to drive the left and right traveling motors.

### BRIEF DESCRIPTION OF THE DRAWINGS

FIG. 1 is a perspective view illustrating an external appearance of a forklift.

FIG. 2 is a view illustrating an example of an operation panel of the forklift.

FIG. 3 is a block diagram illustrating configurations of an electric system and a mechanical system of the forklift.

FIGS. 4A and 4B are views schematically illustrating a dual motor type forklift.

FIG. 5 is a block diagram illustrating a configuration of a motor drive apparatus according to one embodiment.

FIG. 6 is a graph illustrating a speed limit curve.

FIGS. 7A and 7B are block diagrams illustrating a specific configuration example of a turning speed limit unit.

FIG. 8 is a block diagram illustrating a configuration of a motor drive apparatus according to another embodiment.

FIG. 9 is a view illustrating movement of a vehicle when the vehicle turns to the right.

FIGS. 10A to 10E are waveform charts illustrating a turning angle, a time differential, a correction amount, a first speed command value output from a turning speed limit unit, and a second speed command value output from a speed correction unit.

FIG. 11 is a tracking chart illustrating a relation between a turning angle and a speed command value corresponding to FIG. 10.

FIG. 12 is a tracking chart illustrating a relation between a turning angle and a speed command value when a handle turns at a different speed.

FIG. 13 is a time waveform chart of a turning angle and a yaw rate.

FIG. 14 is a view illustrating the forklift turning to the left in a state of loading cargo.

FIG. 15 is a graph illustrating a relation between a yaw rate and a cargo collapse amount.

FIGS. 16A and 16B are frequency distribution charts of a cargo collapse amount and a yaw rate.

### DETAILED DESCRIPTION

Since a forklift is used in a limited working area, the forklift may have an effect of a smaller turn, compared to ordinary vehicles, in other words, the forklift may have a very small turning radius. Accordingly, in a case in which no limit is applied to a vehicle, the vehicle may have an unstable posture when an accelerator is stepped on when a turning radius of the vehicle is small. The related art discloses a technique to increase stability of a forklift.

It is desirable to provide a technique to reduce user discomfort caused when a forklift turns and/or to stabilize behavior of a vehicle body, by means of an approach different from the related art.

According to an aspect, user discomfort may be reduced and/or behavior of the vehicle body may be stable, by performing a speed limit such that an angular velocity with respect to a center of rotation is equal to or less than a threshold value.

The motor drive apparatus may further include a speed correction unit configured to correct the speed command value according to a time differential value δ′ of the turning angle δ.

Even when the speed of a vehicle is constant, the angular velocity with respect to the center of rotation, namely, an acceleration of the vehicle body in a rotation radius direction thereof is changed according to a speed of turning a steering, namely, the time differential value δ′ of the turning angle δ. According to the aspect, it may be possible to reduce discomfort caused by a handle operation or instability of the vehicle.

The speed correction unit may also be grasped when the speed limit curve is corrected.

The speed correction unit may decrease the speed command value when an absolute value of the turning angle δ is increased, and may increase the speed command value when the absolute value of the turning angle δ is decreased.

When the steering is rapidly turned, there is a possibility of an acceleration in a turning radius direction being increased, and a user feeling discomfort or the vehicle body being unstable. According to the aspect, by decreasing the speed command value when the absolute value of the turning angle δ is increased, behavior of the vehicle may be further stable and/or user discomfort may be reduced even when the handle is rapidly turned. Meanwhile, when the absolute value of the turning angle δ is decreased, namely, when the steering is returned, the vehicle body is changed from an unstable state to a stable state. Therefore, there is little possibility of instability of the vehicle from causing damage and the user feeling discomfort even though the speed command value is increased. Accordingly, it may be possible to reduce stress of the user caused by the limit of the vehicle speed by increasing the vehicle speed.

When the speed limit curve is indicated by f(δ) as a function of the turning angle δ, the speed correction unit may add or subtract a correction amount, which is proportional to df(δ)/dδ×δ′ , to or from the speed command value.

When a correction coefficient is set as Cg, the correction amount may be Cg×df(δ)/dδ×δ′ . In this case, it may be possible to adjust (i) stability of the vehicle during turning thereof and user discomfort, and (ii) user stress caused by the limit of traveling performance in a balanced manner, by optimizing the correction coefficient Cg.

The motor drive apparatus may further include a lamp control unit configured to limit a change rate of the speed command value to be a certain value or less.

The turning speed limit unit may include a low-pass filter configured to filter the speed command value output to the drive unit.

When the turning speed limit unit is provided, there is a possibility of the upper limit value in the turning speed limit unit being changed when the turning angle is rapidly operated and the vehicle being rapidly accelerated or decelerated. The provision of the low-pass filter may suppress the rapid acceleration or deceleration of the vehicle.

The low-pass filter may be configured such that a time constant thereof is switchable to at least two values.

In order for the vehicle traveling straight at a high speed to a certain extent to be turned, the turning angle is increased. In this case, the upper limit value in the turning speed limit unit is lowered as the turning angle is increased. In this case, when the time constant of the low-pass filter is fixedly set to be a great value to a certain extent, a situation in which the yaw rate exceeds a threshold value may temporarily occur by a response delay of the low-pass filter, without immediately decreasing the speed command value output from the drive unit to the upper limit value corresponding to the turning angle. Accordingly, by variably configuring the time constant, namely, a cut-off frequency of the low-pass filter and suppressing the time constant according to states of the vehicle, the yaw rate may be suppressed from exceeding the threshold value.

The time constant of the low-pass filter may be set as a first value when the speed command value input to the drive unit is increased, and may be set as a second value less than the first value when the speed command value input to the drive unit is decreased.

Consequently, when the absolute value of the turning angle is decreased, the rapid acceleration of the vehicle may be prevented. On the contrary, when the absolute value of the turning angle is increased, the vehicle speed may be promptly lowered based on the speed limit curve.

The time constant of the low-pass filter may be switched according to the speed command value output from the turning speed limit unit.

The time constant of the low-pass filter may be switched according to the turning angle.

The threshold value may be constant regardless of the turning angle. The threshold value may be set in a range of 60 deg/sec to 80 deg/sec.

The threshold value may be determined according to the turning angle. In more detail, the threshold value may increase as the absolute value of the turning angle increases. On the contrary, the threshold value may decrease as the absolute value of the turning angle increases.

According to another aspect, it may be possible to reduce user discomfort.

Furthermore, as effective aspects of certain embodiments of the present invention, combination of the above components, and the components and expressions of the embodiments may also be mutually substituted between methods, apparatuses, systems, etc.

According to the certain embodiments of the invention, it is possible to reduce user discomfort.

Hereinafter, exemplary embodiments of the present invention will be described with reference to the drawings. Like reference numerals refer to the same or like components, members, or processing throughout the various figures, and redundant description thereof will be properly omitted. In addition, the embodiments are exemplary rather than limiting the disclosure of the present invention, and the essential disclosures of the embodiments of the present invention are not necessarily limited to all characteristics and combinations disclosed in the embodiments.

In the description, “a state in which a member A is connected to a member B” involves a case in which the member A and the member B are indirectly interconnected through other members so as not to substantially affect an electric connection state thereof or so as not to damage functions and effects accomplished by a combination thereof, in addition to a case in which the member A and the member B are physically and directly interconnected.

Similarly, “a state in which a member C is provided between a member A and a member B” involves a case in which the member A and the member C or the member B and the member C are indirectly interconnected through other members so as not to substantially affect an electric connection state thereof or so as not to damage functions and effects accomplished by a combination thereof, in addition to a case in which the member A and the member C or the member B and the member C are physically and directly interconnected.

### One Embodiment

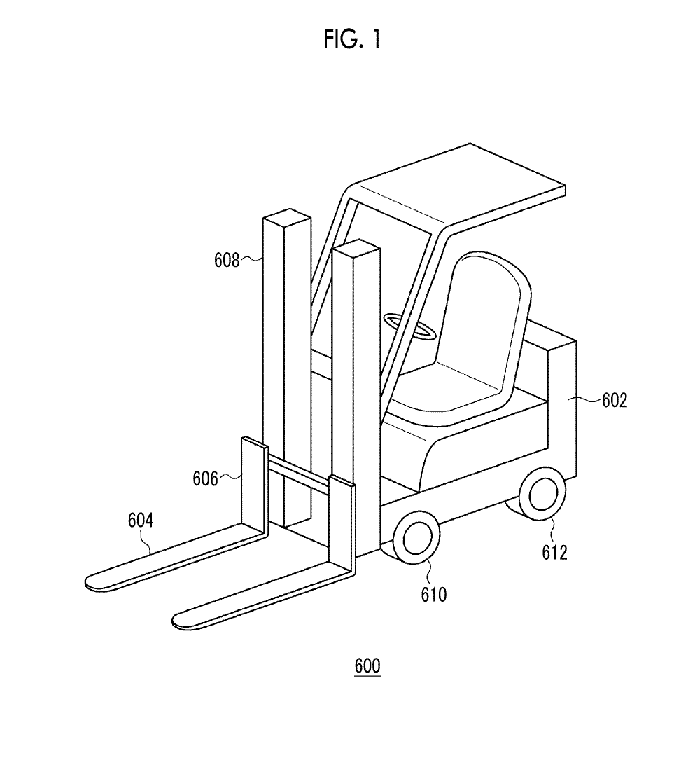

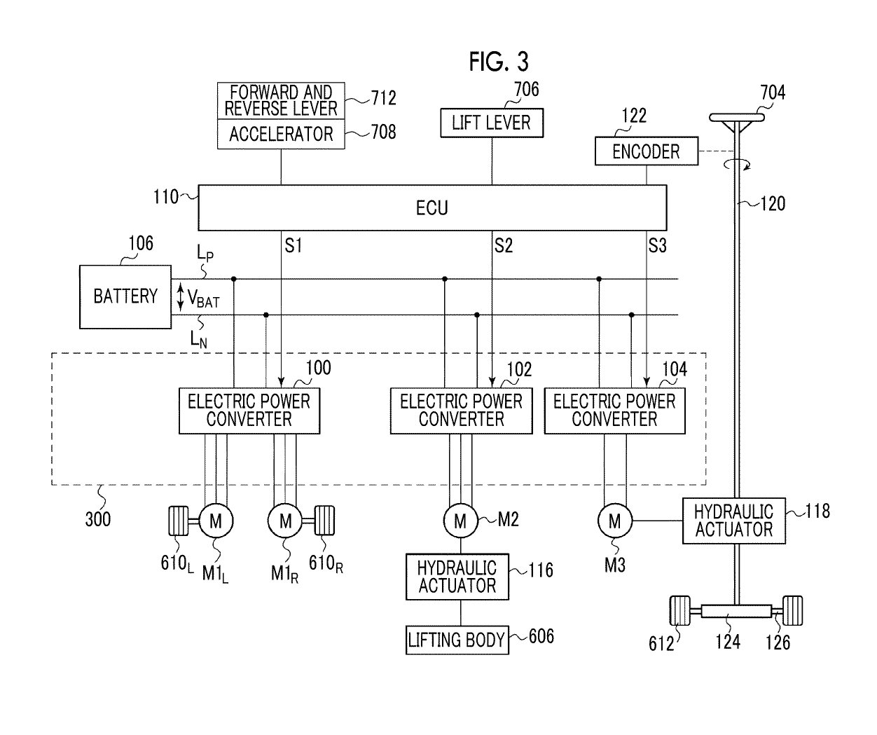

FIG. 1 is a perspective view illustrating an external appearance of a forklift. A forklift 600 includes a vehicle body (a chassis) 602, a fork 604, a lifting body (a lift) 606, a mast 608, and wheels 610 and 612. The mast 608 is provided in the front of the vehicle body 602. The lifting body 606 is driven by a drive source such as a hydraulic actuator (not shown in FIG. 1 and see reference numeral 116 of FIG. 3) to be vertically moved along the mast 608. The fork 604 for supporting cargo is attached to the lifting body 606.

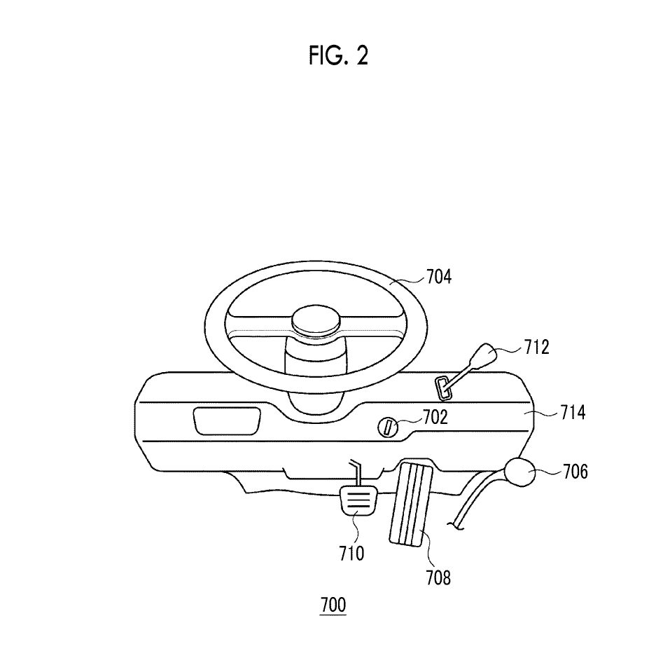

FIG. 2 is a view illustrating an example of an operation panel 700 of the forklift. The operation panel 700 includes an ignition switch 702, a steering wheel 704, a lift lever 706, an accelerator pedal 708, a brake pedal 710, a dashboard 714, and a forward and reverse lever 712.

The ignition switch 702 is a switch for starting of the forklift 600. The steering wheel 704 is an operation section which steers the forklift 600. The lift lever 706 is an operation section which vertically moves the lifting body 606. The accelerator pedal 708 is an operation section which controls rotation of traveling wheels, and traveling of the forklift 600 is controlled by adjusting an amount of the pedal stepped on by a user. When the user steps on the brake pedal 710, a brake is worked. The forward and reverse lever 712 is a lever for switching a traveling direction of the forklift 600 between a forward direction and a reverse direction. Besides, an inching pedal (not shown) may also be provided.

Next, each of the configuration, traveling, cargo handling, and steering of the forklift 600 will be described. FIG. 3 is a block diagram illustrating configurations of an electric system and a mechanical system of the dual motor type forklift 600. An ECU (an electronic control controller) 110 is a processor for controlling the forklift 600 as a whole.

A battery 106 outputs a battery voltage V_{BAT} between a P line and an N line.

A motor drive apparatus 300 drives each of traveling motors M1L and M1R, a cargo handling motor M2, and a steering motor M3, based on first to third control command values S1 to S3 from the ECU110. Specifically, the motor drive apparatus 300 includes a traveling motor drive apparatus 100, a cargo handling motor drive apparatus 102, and a steering motor drive apparatus 104. Each of the traveling motor drive apparatus 100, the cargo handling motor drive apparatus 102, and the steering motor drive apparatus 104 is an electric power converter in which the battery voltage V_{BAT} is received and converted into a three-phase alternating current signal or a single-phase alternating current signal, so as to be supplied to the corresponding motor M1L, M1R, M2, or M3.

[Traveling]

The ECU 110 receives a signal which commands forward traveling or reverse traveling from the forward and reverse lever 712 and a signal indicative of a traveling operation amount corresponding to a stepped amount from the accelerator pedal 708, and outputs a first control command value S1 corresponding to the signals to the traveling motor drive apparatus 100. The traveling motor drive apparatus 100 controls electric power supplied to each of the left traveling motor M1L and the right traveling motor M1R, according to the first control command value S1. The first control command value S1 has a correlation with a speed command value which commands a target speed of each traveling motor M1. A left front wheel (a left drive wheel) 610L and a right front wheel (a right drive wheel) 610R, which are drive wheels, are rotated by power of the respective left and right traveling motors M1L and M1R.

[Cargo Handling]

Vertical movement of the lifting body 606 is controlled by an inclination of the lift lever 706. The ECU 110 detects an inclination of the lift lever 706, and outputs a second control command value S2 indicative of a cargo handling operation amount corresponding to the inclination to the cargo handling motor drive apparatus 102. The cargo handling motor drive apparatus 102 supplies electric power corresponding to the second control command value S2 to the cargo handling motor M2, and controls rotation thereof. The lifting body 606 is connected to the hydraulic actuator 116. The hydraulic actuator 116 converts a rotational motion generated by the cargo handling motor M2 into a linear motion, and controls the lifting body 606.

[Steering]

An encoder 122 detects a rotation angle of the steering wheel 704, and outputs a signal indicative of the rotation angle to the ECU 110. The ECU 110 outputs a third control command value S3 corresponding to the rotation angle to the steering motor drive apparatus 104. The steering motor drive apparatus 104 supplies electric power corresponding to the third control command value S3 to the steering motor M3, and controls a rotation speed thereof. Rear wheels 612 as turning wheels are connected to a gearbox 124 through a tie rod 126. A rotational motion of the steering motor M3 is transferred to the tie rod 126 through a hydraulic actuator 118 and the gearbox 124, and the steering is controlled.

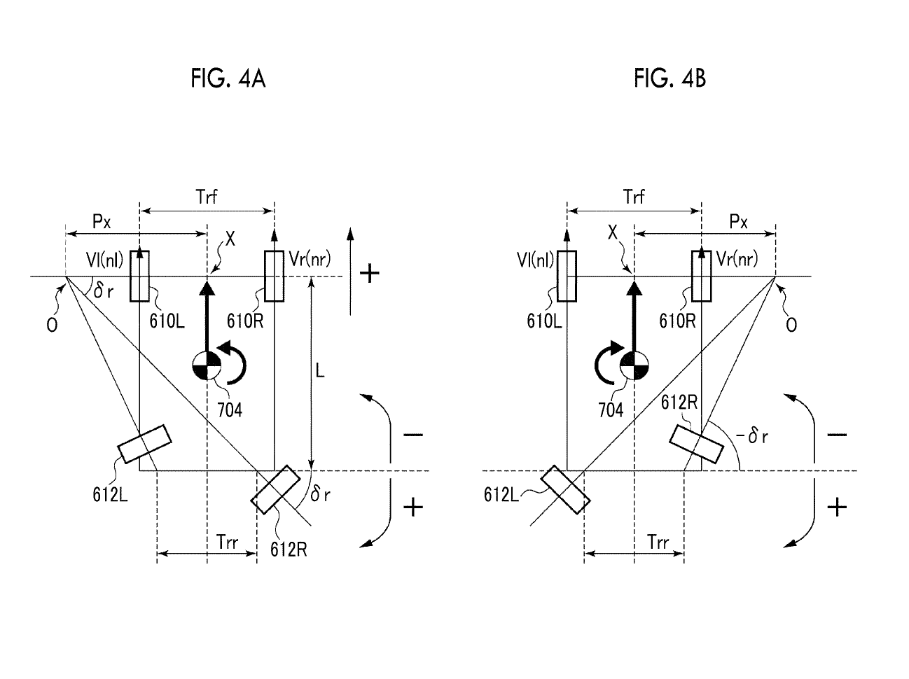

FIGS. 4A and 4B are views schematically illustrating the dual motor type forklift 600. Reference numeral L refers to a wheelbase, reference numeral Trf refers to a front tread, reference numeral Trr refers to a rear tread, reference numeral nl (rpm) refers to a speed of the left drive wheel 610L, reference numeral nr (rpm) refers to a speed of the right drive wheel 610R, reference numeral Vl (m/s) refers to a speed of the left drive wheel 610L, and reference numeral Vr (m/s) refers to a speed of the right drive wheel 610R.

Turning angles of the rear wheels 612L and 612R as turning wheels are controllable by an Ackermann steering mechanism. An intersection point of axles of the respective rear wheels 612L and 612R is a center of rotation O of the vehicle body, and the center of rotation O horizontally moves on an axle of each front wheel 610L or 610R, according to a turning angle δᵣ. Although the turning angle δᵣ is defined as a rotation angle of the right rear wheel in the embodiment, it is understood by those skilled in the art that the definition of the turning angle δᵣ is not limited thereto. The turning angle δᵣ indicates a plus during left turning shown in FIG. 4A and a minus during right turning shown in FIG. 4B.

Reference numeral ρₓ is a distance between the center of rotation O and an intermediate point (referred to as “a vehicle body representative point X”) of the front wheels 610L and 610R, namely, is a turning radius.

The steering mechanism of the forklift 600 allows the center of rotation O to move between the front wheels 610L and 610R. In this case, the left and right drive wheels 610L and 610R are controlled so as to reversely rotate.

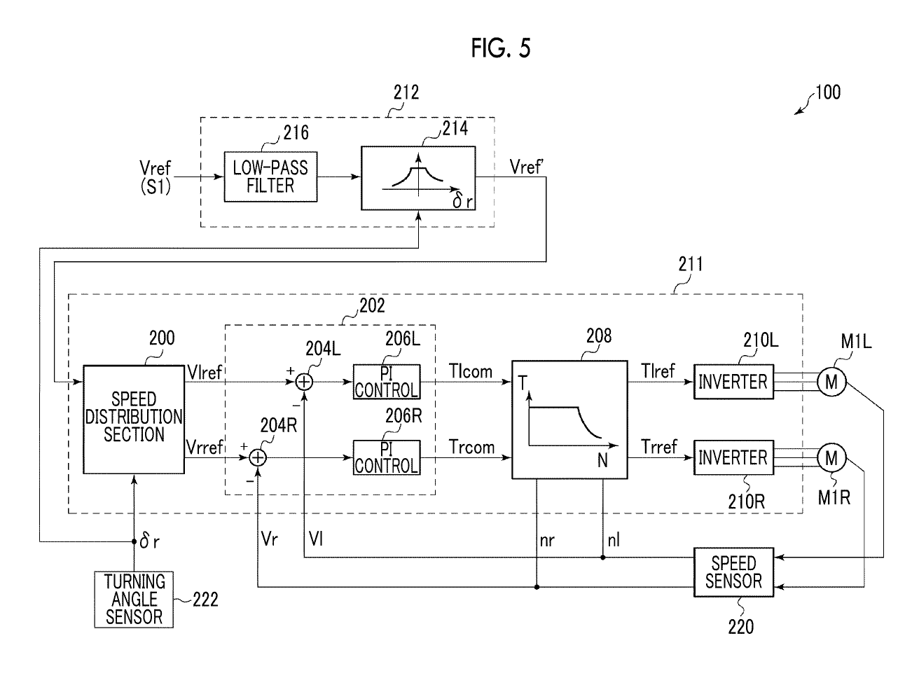

FIG. 5 is a block diagram illustrating a configuration of the traveling motor drive apparatus (hereinafter, simply referred to as “the motor drive apparatus”) 100 according to one embodiment. The motor drive apparatus 100 includes a drive unit 211, a turning speed limit unit 212, a speed sensor 220, and a turning angle sensor 222.

The turning angle sensor 222 detects the turning angle δᵣ shown in FIG. 3. The speed sensor 220 detects speeds nl(Vl) and nr(Vr) of the respective left and right traveling motors M1L and M1R.

The turning speed limit unit 212 receives a speed command value Vref corresponding to the operation amount of the accelerator. In the embodiment, the speed command value Vref refers to speeds of the left and right wheels during straight traveling, a speed of the right drive wheel during left turning, and a speed of the left drive wheel during right turning.

In the turning speed limit unit 212, a speed limit curve Vₗᵢₘ(δᵣ), which stipulates an upper limit value of the speed of the forklift 600, is defined. The speed limit curve Vₗᵢₘ(δᵣ) is defined as a function of the turning angle δᵣ of the forklift such that an angular velocity about a z-axis (hereinafter, referred to as “a yaw rate”) ω with respect to a center of rotation of the forklift 600 does not exceed a threshold value ω₀. Furthermore, the speed limit curve Vₗᵢₘ(δᵣ) has a constant value in the vicinity at which δᵣ becomes 0°, but this depends on a limit of a maximum speed of the forklift 600.

The turning speed limit unit 212 limits the speed command value Vref corresponding to the stepped amount of the accelerator to an upper limit value Vₗᵢₘ or less determined according to the speed limit curve Vₗᵢₘ(δᵣ) and the turning angle δ.

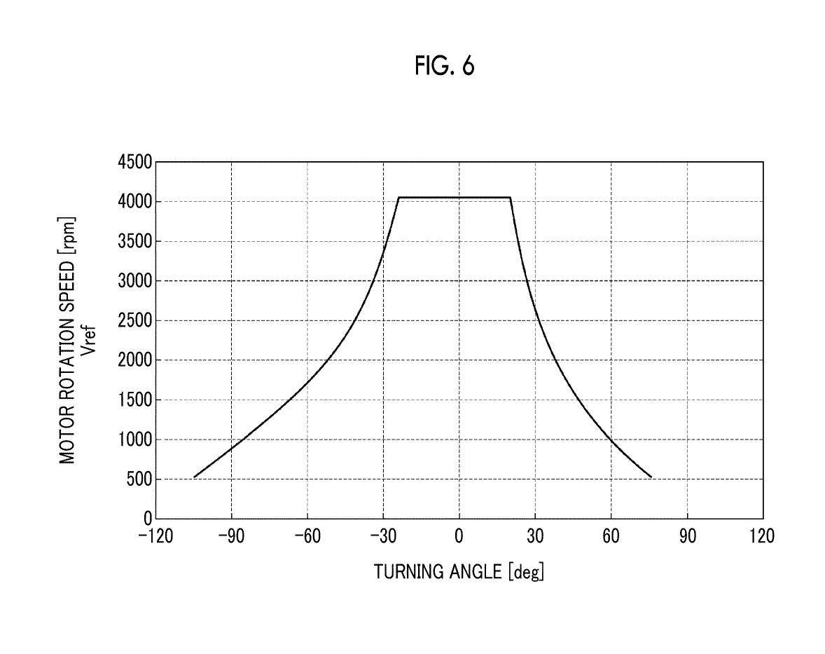

FIG. 6 is a graph illustrating the speed limit curve Vₗᵢₘ(δᵣ). The horizontal axis indicates a turning angle δᵣ and the vertical axis Vref indicates a vehicle speed. The vertical axis is indicated by a value obtained by converting the vehicle speed into a rotation speed of the traveling motor M1 (outer wheel).

Referring to FIG. 4A, a distance ρₓ′ between a center of the outer wheel during the left turning and the center of rotation is given by Equation (1).

ρₓ′=ρₓ+Trf/2 (1)

ρₓ=L/tan(δᵣ)−Trr/2 (2)

When the speed of the right front wheel as the outer wheel is Vref, a yaw rate ω (rad/sec) which is an angular velocity about the center of rotation O is,

ω=Vref/ρₓ′.

Accordingly, in order for the yaw rate ω not to exceed a threshold value ω₀,

ω₀×ρₓ′>Vref may be established.

Accordingly, ω₀×ρₓ′ is set to be the speed limit curve Vₗᵢₘ(δᵣ) and is given by Equation (3).

Vₗᵢₘ(δᵣ)=ω₀×{L/tan(δᵣ)−Trr/2+Trf/2} (3)

In the embodiment, the threshold value ω₀ is constant regardless of the turning angle δᵣ. FIG. 6 shows a speed limit curve corresponding to ω₀=π/3[rad]=60 [deg] . A range of the threshold value ω₀ capable of suppressing user discomfort without damage to an operation feeling of the forklift 600 is 60 degrees to 80 degrees.

The speed limit curve Vₗᵢₘ of FIG. 6 is left-right asymmetric since the turning angle δᵣ is defined as a rotation angle of the right rear wheel. It is understood by those skilled in the art that the speed limit curve Vₗᵢₘ depends on the definition of the turning angle δᵣ and certain embodiments of the present invention are applicable regardless of the definition of the turning angle δᵣ.

The turning speed limit unit 212 includes a limit execution section 214 and a low-pass filter 216. The limit execution section 214 limits the speed command value Vref, based on the speed limit curve Vₗᵢₘ. The low-pass filter 216 filters the speed command value Vref, in order to suppress a rapid variation of a speed command value Vref′ which is output to the drive unit 211.

The low-pass filter 216 is configured such that a cut-off frequency, namely, a time constant thereof may be switched to at least two values.

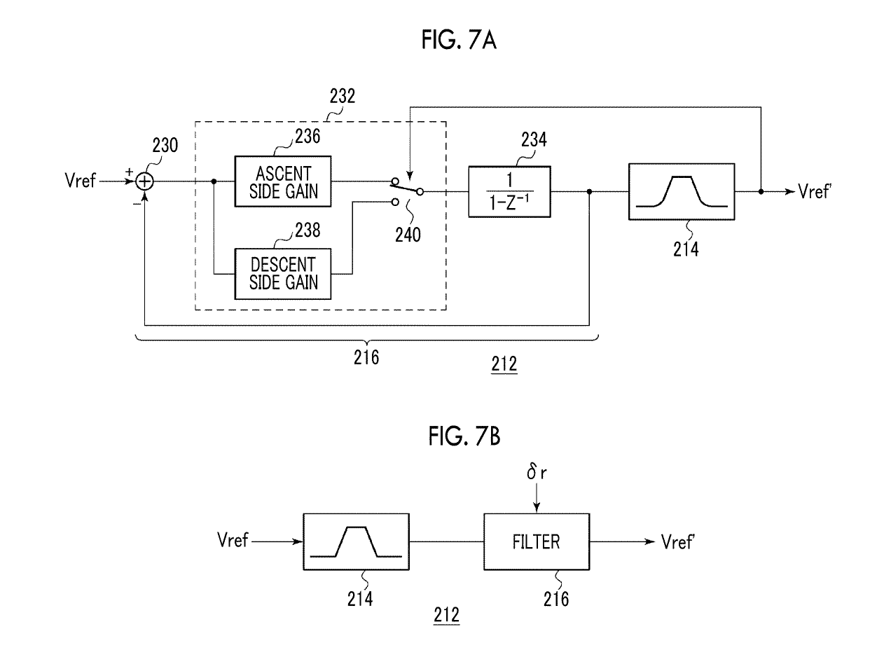

FIGS. 7A and 7B are block diagrams illustrating a specific configuration example of the turning speed limit unit 212. The low-pass filter 216 in FIG. 7A is a primary IIR (Infinite Impulse Response) filter, and includes an adder 230, a coefficient multiplication section 232, and an integrator 234.

The adder 230 subtracts an output from an input of the low-pass filter 216. The coefficient multiplication section 232 multiplies the output of the adder 230 by a coefficient (gain) determined according to the time constant (cut-off frequency) of the low-pass filter. A first coefficient retention section 236 retains a first coefficient, and multiplies the output value of the adder 230 by the first coefficient. The first coefficient retention section 236 retains a second coefficient greater than the first coefficient, and multiplies the output value of the adder 230 by the second coefficient. A coefficient selection section 240 selects a value multiplied by the first or second coefficient, and outputs the value to the subsequent limit execution section 214. According to such a configuration, the time constant of the coefficient multiplication section 232 may be switched to two values.

The cut-off frequency (time constant) of the low-pass filter 216 may also be switched according to the speed command value Vref′ output from the turning speed limit unit 212. In more detail, when the speed command value Vref′ is changed in an increasing direction, the coefficient of the coefficient multiplication section 232 is set to be small, that is, the first coefficient retention section 236 is selected, the cut-off frequency is set to be low, and the time constant is set to be long.

On the contrary, when the speed command value Vref′ is changed in a decreasing direction, the coefficient of the coefficient multiplication section 232 is set to be great, that is, the second coefficient retention section 238 is selected, the cut-off frequency is set to be high, and the time constant is set to be short.

In the coefficient multiplication section 232, the coefficient may also be controlled based on the turning angle δᵣ, instead of the speed command value Vref′. That is, when an absolute value of the turning angle δᵣ increases, the time constant of the low-pass filter 216 is set to be small and the cut-off frequency is set to be high. On the contrary, when the absolute value of the turning angle δᵣ decreases, the time constant of the low-pass filter 216 is set to be great and the cut-off frequency is set to be low. According to such control, the low-pass filter 216 may be properly controlled.

In the turning speed limit unit 212 of FIG. 7B, the limit execution section 214 is provided prior to the low-pass filter 216. The time constant of the low-pass filter 216 may be switched according to the turning angle δᵣ.

Furthermore, even in the configuration of FIG. 7B, the time constant of the low-pass filter 216 may also be switched based on the speed command value Vref′.

Returning to FIG. 5 again, the drive unit 211 drives the left and right traveling motors M1L and M1R, according to a speed command value Vref′, subjected to the limit, which is output from the turning speed limit unit 212. The configuration of the drive unit 211 is not particularly limited. For example, the drive unit 211 includes a speed distribution section 200, a torque command value generation section 202, a torque limit section 208, and an inverter 210.

The speed distribution section 200 calculates a left speed command value Vlref as a target speed of the left traveling motor M1L and a right speed command value Vrref as a target speed of the right traveling motor M1R, according to a current turning angle δᵣ, based on the following Equations.

δᵣ=0 (straight traveling)

Vlref=Vrref=Vref 1.

δᵣ >0 (left turning)

Vrref=Vref

Vlref=(ρₓ−Trf/2)/(ρₓ+Trf/2)×Vref 2.

Where ρₓ=L/tan(δᵣ)−Trr/2.

δᵣ<0 (right turning)

Vrref=(ρₓ−Trf/2)/(ρₓ+Trf/2)×Vref

Vlref=Vref 3.

Where ρₓ=−L/tan(δᵣ)+Trr/2 in a case of δᵣ≠−π/2, and ρₓ=Trr/2 in a case of δᵣ=−π/2.

Furthermore, the speed distribution section 200 may also use a known technique, and the configuration and calculation algorithm thereof are not limited to the above method.

The torque command value generation section 202 generates a left torque command value Tlcom which commands torque of the left traveling motor M1L, according to an error between a left speed command value Vlref and a current speed nl of the left traveling motor M1L. Similarly, the torque command value generation section 202 generates a right torque command value Trcom which commands torque of the right traveling motor M1R, according to an error between a right speed command value Vrref and a current speed Vr of the right traveling motor M1R.

The torque command value generation section 202 includes a subtracter 204L which generates an error between a left speed command value Vlref and a current speed Vl of the left traveling motor M1L, and a PI control section 206L which controls the error in a PI (proportional, integral) manner and generates a left torque command value Tlcom. The right wheel is also similar.

In the torque limit section 208, a torque limit curve Tₗᵢₘ(n) which stipulates an upper limit value Tₗᵢₘ of each of the torque command values Tlcom and Trcom, is defined as a function of the speed n of the motor.

The torque limit section 208 limits the left torque command value Tlcom to the upper limit value Tlₗᵢₘ or less determined according to the speed nl of current left traveling motor M1L and the torque limit curve Tₗᵢₘ(n). Similarly, the torque limit section 208 limits the right torque command value Trcom to the upper limit value Trₗᵢₘ or less determined according to the speed nr of current right traveling motor M1R and the torque limit curve Tₗᵢₘ(n). The torque limit curve Tₗᵢₘ(n) may also be retained as a table or may also be retained as an approximation formula.

The configuration of the motor drive apparatus 100 has been described above. Next, the operation of the forklift 600 will be described.

1. A case in which the absolute value of the turning angle δᵣ is increased when the vehicle travels straight at a high speed

In an initial state, the vehicle travels straight and the speed thereof reaches a limited value. From this state, when the user greatly turns the handle, that is, when the absolute value of the turning angle δᵣ is increased, the upper limit value Vₗᵢₘ determined by the speed limit curve Vₗᵢₘ(δᵣ) is lowered. In this case, since the time constant of the low-pass filter 216 is small, the output Vref′ of the turning speed limit unit 212 is promptly lowered according to a change of the upper limit value Vₗᵢₘ of speed accompanying a change of δᵣ.

2. A case in which the absolute value of the turning angle δᵣ is decreased when the vehicle turns and travels at a high speed

In an initial state, the vehicle turns and the speed thereof reaches a limited value. From this state, when the user greatly returns the handle, that is, when the absolute value of the turning angle δᵣ is decreased, the upper limit value Vₗᵢₘ determined by the speed limit curve Vₗᵢₘ(δᵣ) is increased. In this case, since the time constant of the low-pass filter 216 is great, the output Vref′ of the turning speed limit unit 212 follows behind a change of the upper limit value Vₗᵢₘ of speed accompanying a change of δᵣ.

3. A case in which the vehicle speed is increased when the vehicle turns and travels

In an initial state, the vehicle turns and the speed thereof is low. In this state, when the user steps on the accelerator, the speed command value Vref is increased but the speed command value Vref input to the drive unit 211 is limited to the upper limit value determined by the speed limit curve Vₗᵢₘ(δᵣ).

The operation of the forklift 600 has been described above.

In accordance with the motor drive apparatus according to the embodiment, the speed limit may be performed such that the angular velocity (the yaw rate) with respect to the center of rotation O is the threshold value ω₀ or less, and it may be possible to reduce user discomfort.

In addition, the following effects may be obtained by providing the low-pass filter. That is, when the limit execution section 214 is provided alone, there is a possibility of the upper limit value in the turning speed limit unit being changed when the turning angle δᵣ is rapidly operated and the vehicle being rapidly accelerated or decelerated. In contrast, the provision of the low-pass filter 216 may suppress the rapid acceleration or deceleration of the vehicle.

In the embodiment, the time constant of the low-pass filter 216 is set as a first value when the speed command value Vref′ increases (rises), and the time constant of the low-pass filter 216 is set as a second value less than the first value when the speed command value Vref′ decreases. Consequently, when the absolute value of the turning angle δᵣ is set to be small during high-speed traveling, the rapid acceleration of the vehicle may be prevented. On the contrary, when the absolute value of the turning angle δᵣ is set to be great during high-speed traveling, the vehicle speed may be promptly lowered along the upper limit value curve. Thereby, the yaw rate may be prevented from exceeding a threshold value under various situations.

### Another Embodiment

A forklift has a greater variable width of a turning angle δᵣ, compared to ordinary vehicles. In addition, a change rate (namely, a time differential value δᵣ′) of the turning angle δᵣ significantly differs for each user or for each use environment. In view of unique characteristics of the forklift, another embodiment will describe a technique to improve instability of a vehicle body and user discomfort caused by a handle operation.

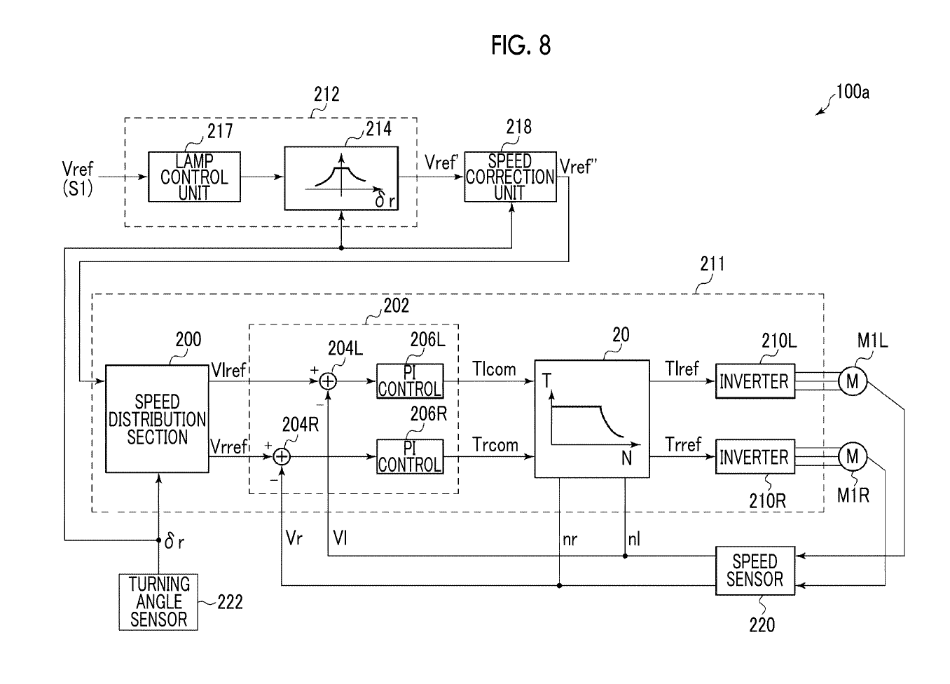

FIG. 8 is a block diagram illustrating a configuration of a motor drive apparatus according to another embodiment.

A motor drive apparatus 100a includes a speed correction unit 218, in addition to the components of the motor drive apparatus 100 of FIG. 5. In the embodiment, a low-pass filter 216 of a turning speed limit unit 212 may also be eliminated. A lamp control unit 217 in which a change rate of a speed command value Vref is limited (referred to as “is controlled in a lamp manner or is controlled in a soft start manner”) to be a certain value or less may also be provided in place of the low-pass filter 216.

The speed correction unit 218 is provided subsequent to the turning speed limit unit 212, and further corrects a speed command value (referred to as “a first speed command value”) Vref′ limited by the turning speed limit unit 212, according to the time differential value δᵣ′ of the turning angle δᵣ. A corrected speed command value (referred to as “a second speed command value”) Vref″ is input to a drive unit 211.

The speed correction unit 218 may also be grasped when a speed limit curve Vₗᵢₘ(δᵣ) is corrected.

Specifically, the speed correction unit 218 may also decrease the second speed command value Vref″ when an absolute value of the turning angle δ is increased, namely, in a process of performing an operation of turning a steering, and may also increase the second speed command value Vref″ when the absolute value of the turning angle δ is decreased, namely, in a process of performing an operation to return the steering.

When the speed limit curve Vₗᵢₘ(δᵣ) is indicated by f(δ) as a function of the turning angle δᵣ, the speed correction unit 218 adds or subtracts a correction amount ΔVref, which is proportional to df(δᵣ)/dδᵣ×δᵣ′, to or from the speed command value.

As described in the previous embodiment, the speed limit curve Vₗᵢₘ(δᵣ) is given by Equation (3).

Vₗᵢₘ(δᵣ)=f(δᵣ)=ω₀×{L/tan(δᵣ)−Trr/2+Trf/2} (3)

In this case, the correction amount ΔVref is given by Equation (4).

$$\begin{matrix}Δ Vref = Cg \times df ( δ ) / d δ \times {δ}^{′} \\ = Cg \times {ω}_{0} \times ( - L / {sin}^{2} {δ}_{r} \times {δ}^{′} )\end{matrix} \qquad ( 4 )$$

The configuration of the motor drive apparatus 100a according to another embodiment has been described above. Next, an operation of the motor drive apparatus 100a will be described.

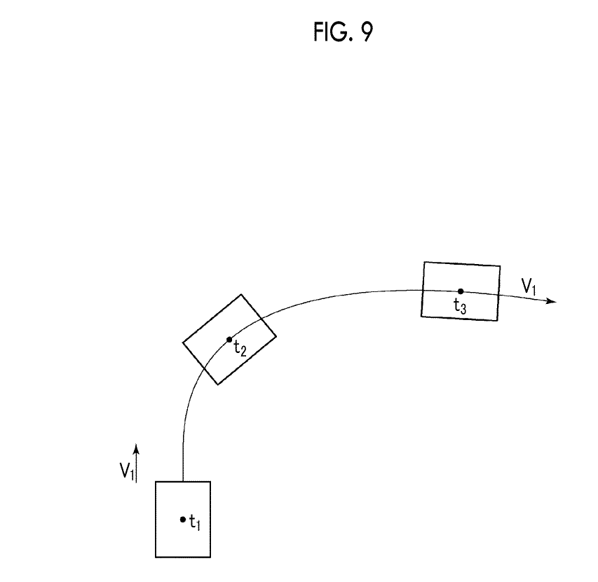

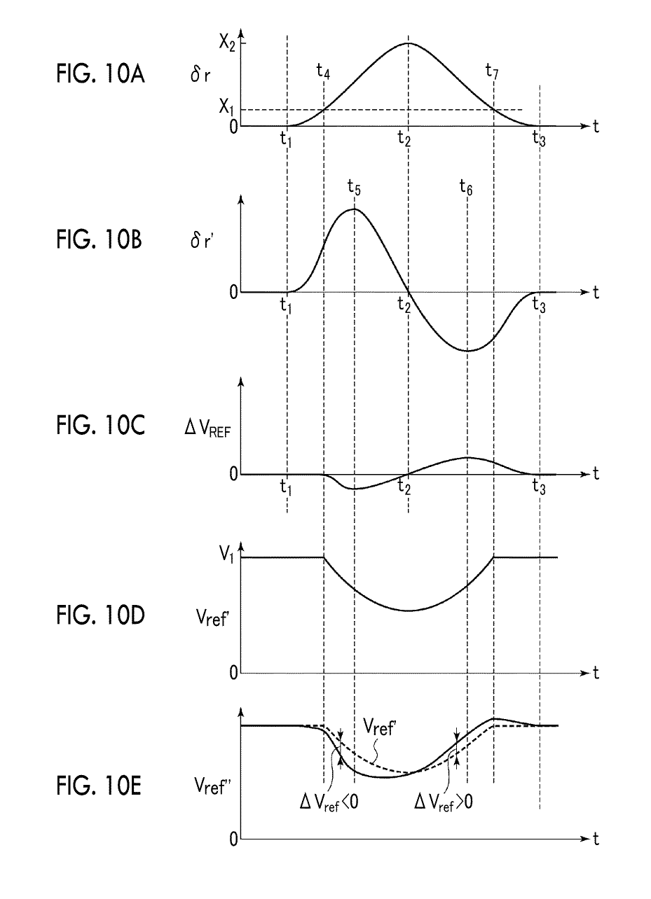

FIG. 9 is a view illustrating movement of the vehicle when the vehicle turns to the right. FIGS. 10A to 10E are waveform charts illustrating the turning angle δᵣ, the time differential δᵣ′, the correction amount ΔVref, the first speed command value Vref′ output from the turning speed limit unit 212, and the second speed command value Vref″ output from the speed correction unit 218.

Prior to an initial state t₁, the vehicle travels straight at a speed V₁. At a time t₁, when the user begins to turn the handle to the right, the turning angle δᵣ increases. At a time t₂, the turning angle δᵣ has a maximum value and decreases again toward “0”. After a time t₃, the turning angle δᵣ is “0”. In addition, the speed command value Vref has a value higher than an upper limit value V1 of a speed limit curve V_{LIM} during traveling.

In the straight traveling before the time t₁, the correction of the speed correction unit 218 is not performed since δᵣ′ is “0”, and thus the second speed command value Vref″ input to the speed distribution section 200 is equal to the first speed command value Vref′ and is limited to the upper limit value V1 of the speed limit curve V_{LIM}.

Between the times t₁ and t₂, the time differential δᵣ′ of the turning angle δᵣ is a positive value as the turning angle δᵣ is increased. Consequently, the correction amount ΔVref given by Equation (4) is a negative value, and the second speed command value Vref″ is smaller than the first speed command value Vref′ .

In a case of δᵣ′=0 at the time t₂, the second speed command value Vref″ coincides with the first speed command value Vref′.

Between the times t₂ and t₃, the time differential δᵣ′ of the turning angle δᵣ is a negative value as the turning angle δᵣ is decreased. Consequently, the correction amount ΔVref given by Equation (4) is a positive value, and the second speed command value Vref″ is greater than the first speed command value Vref′. In a case of δᵣ′=0 at the time t₃, the second speed command value Vref″ coincides with the first speed command value Vref′.

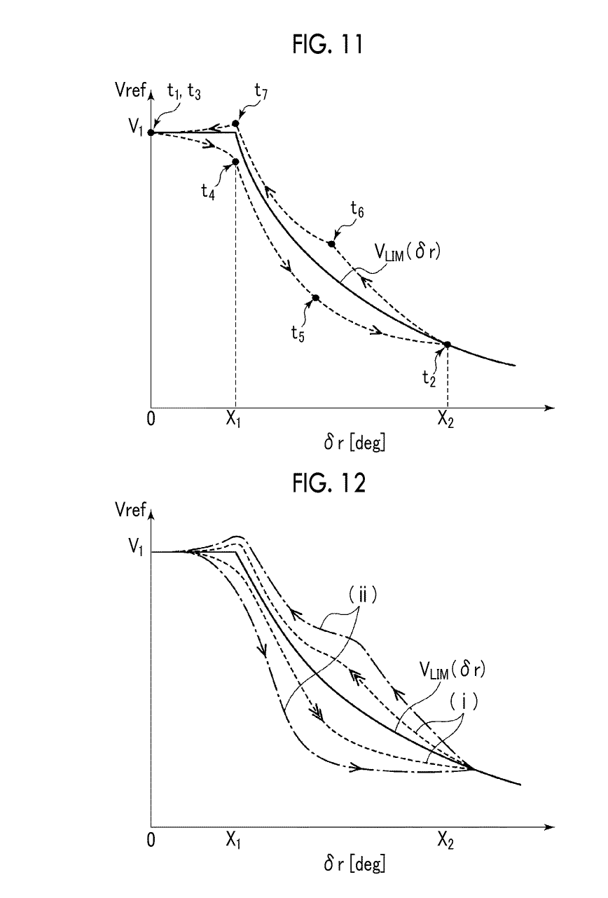

FIG. 11 corresponds to FIG. 10 and is a tracking chart illustrating a relation between the turning angle δᵣ and the speed command value Vref″.

FIG. 12 is a tracking chart illustrating a relation between the turning angle δᵣ and the speed command value Vref″ when the handle turns at a different speed. Here, (i) shows a tracking in a case of performing a slow steering operation and (ii) shows a tracking in a case of performing a rapid steering operation. In the case of performing the rapid steering operation, since the time differential turning angle δᵣ′ of the turning angle δᵣ is increased, the correction amount ΔVref is increased.

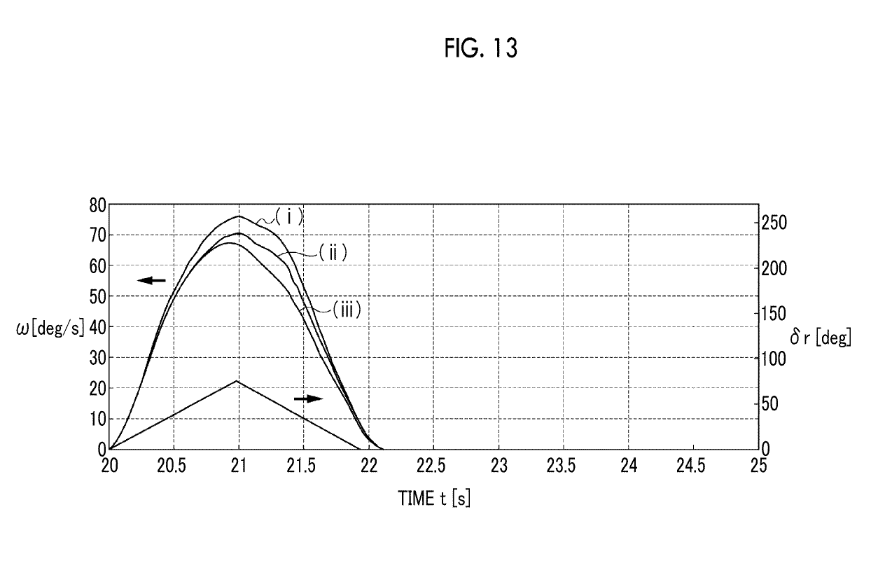

FIG. 13 is a time waveform chart of the turning angle δᵣ and the yaw rate ω. Here, (i) shows a case of not performing the control by the limit execution section 214 and the speed correction unit 218, (ii) shows a case of performing only the control by the limit execution section 214 (one embodiment), and (iii) shows a case of using the control by the limit execution section 214 and the speed correction unit 218 together (another embodiment).

As shown in (iii) of FIG. 13, according to the traveling motor drive apparatus 100a of FIG. 8, it may be seen that the yaw rate ω is more securely suppressed.

The operation of the traveling motor drive apparatus 100a according to another embodiment has been described above.

In the traveling motor drive apparatus 100a, even when the vehicle speed is constant, an angular velocity ω with respect to the center of rotation, namely, an acceleration (lateral G) in a rotation radius direction of the vehicle body is changed according to the speed of turning the steering, namely, the time differential value δ′ of the turning angle δ. According to the traveling motor drive apparatus 100a of FIG. 8, it may be possible to reduce discomfort or instability of the vehicle caused by the handle operation, by correcting the speed using the time differential δᵣ′ of the turning angle δᵣ.

Specifically, the speed correction unit 218 decreases the speed command value Vref″ when the absolute value of the turning angle δ is increased, and increases the speed command value Vref″ when the absolute value of the turning angle δ is decreased.

When the steering is rapidly turned, there is a possibility of the acceleration (lateral G) in the turning radius direction being increased, and the user feeling discomfort or the vehicle body being unstable. According to the traveling motor drive apparatus 100a of FIG. 8, by decreasing the speed command value Vref″ when the absolute value of the turning angle δᵣ is increased, behavior of the vehicle may be further stable and/or user discomfort may be reduced even when the handle is rapidly turned. Meanwhile, when the absolute value of the turning angle δᵣ is decreased, namely, when the steering is returned, the vehicle body is changed from an unstable state to a stable state. Therefore, there is little possibility of stability of the vehicle from causing damage and the user feeling discomfort even though the speed command value Vref″ is increased. Accordingly, it may be possible to reduce stress of the user caused by the limit of the vehicle speed by increasing the vehicle speed.

In addition, it may be possible to adjust (i) stability of the vehicle during turning thereof and user discomfort, and (ii) user stress caused by the limit of traveling performance in a balanced manner, by stipulating Cg as a parameter of a correction coefficient and optimizing the correction coefficient Cg.

Although the traveling motor drive apparatus 100 according to the above embodiments has been described above from the point of view of the stability of the vehicle and the discomfort of the user, the traveling motor drive apparatus 100 according to certain embodiments of the present invention has an effect of being capable of suppressing cargo from falling. Hereinafter, effects thereof will be described.

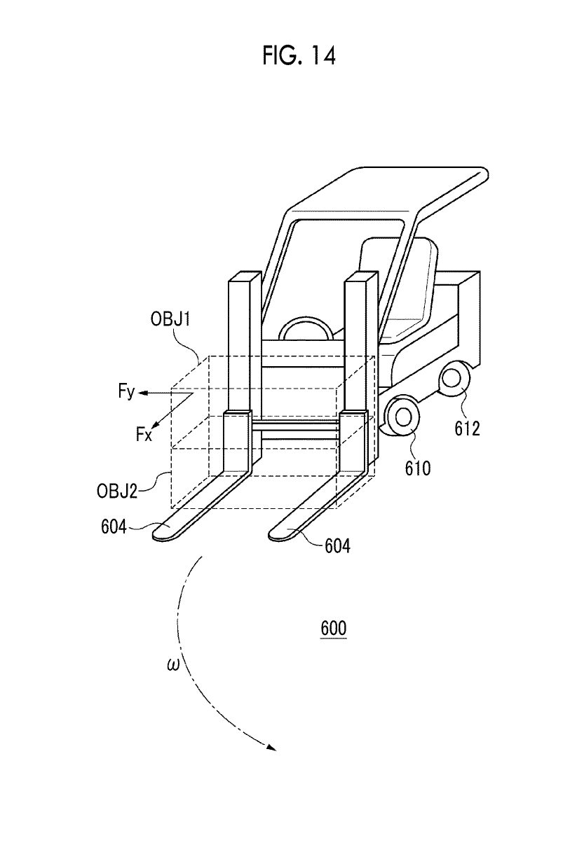

FIG. 14 is a view illustrating the forklift turning to the left in a state of loading cargo. An X-axis refers to a vehicle forward direction and a Y-axis refers to a direction perpendicular thereto. When the forklift travels, cargo should not fall from the forklift. A cargo OBJ is typical corrugated cardboard, and several pieces of corrugated cardboard are vertically stacked on the fork 604.

If paying attention to the uppermost cargo OBJ1, forces applied to the cargo OBJ1 during traveling are (i) a frictional force, F₀=μ·M·g−F_{V}, which is generated between the cargo OBJ1 and one lower cargo OBJ2, (ii) a force, Fₓ=M·Vₓ′, which is proportional to an acceleration in an X direction accompanying departure, acceleration, and stop, and (iii) a centrifugal force, F_{y}=M·R·ω², which is generated in a turning radius direction, namely, in a Y direction when the vehicle turns. Here, μ is a coefficient of static friction between the pieces of corrugated cardboard, g is an acceleration of gravity, M is a mass of the cargo OBJ1, and F_{V} is an influence by vibration. A correction term of vibration F_{V} represents that a partial mass of the cargo is decreased and the frictional force F₀ is decreased, by vibration of the vehicle in a pitch direction thereof. The correction term F_{V} may be reduced to a negligible level by pitching compensations, and thus the correction term F_{V} will be omitted below.

From the above configuration, the following Equation is obtained as a conditional expression for preventing cargo from falling:

F₀>F_{X}+F_{y}

μ·M·g>M·V_{X}′+M·R·ω²

where F_{X}+F_{y} means vector synthesis. When F_{X}+F_{y} is less than a static friction force, cargo may be maintained in a stable state.

μ·g>V_{X}′+R·ω²

Here, it is assumed that a predetermined maximum value Vz′_{MAX} is set as V_{z}′. Then, a condition for preventing cargo from falling is,

μ·g−Vz′_{MAX}>R·ω² (5).

Here, μ may suppose a value (0.3 to 0.8) at a contact surface between the pieces of corrugated cardboard, and g is also known. Then, the left side of the inequality (5) may suppose a certain constant K, and the following inequality (6) is obtained.

K>R·ω²

The lateral G is stipulated as a function, r·ω², of a turning radius and a turning angular velocity. Accordingly, the turning radius R and the yaw rate ω may be adapted to be controlled in such a manner that the lateral G for allowing cargo to fall is set as an upper limit K and is equal to or less than the upper limit.

In the embodiment, the lateral G may be suppressed to be a predetermined constant K or less by setting a handle operation amount by a driver, as it is, as a turning radius command value and controlling the yaw rate ω, and cargo may be prevented from falling. A turning radius R at which cargo easily collapses may be empirically or experimentally known. In this case, the cargo may be prevented from falling by setting the turning radius as R₀ and limiting the yaw rate ω so as to satisfy the following equation.

K/R₀>ω²

An upper limit ω₀ of the yaw rate ω may be experimentally determined.

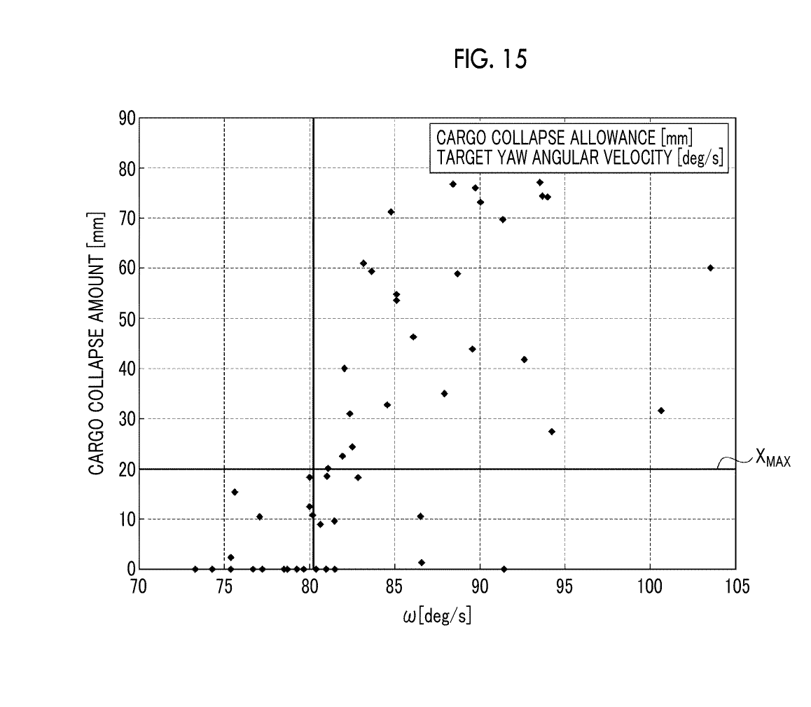

FIG. 15 is a graph illustrating a relation between a yaw rate ω and a cargo collapse amount. FIG. 15 is a distribution chart in which the forklift travels at various yaw rates for plotting how many mm the cargo is moved at each yaw rate. When the cargo is moved to the extent of several mm or less, the cargo does not fall. Accordingly, an allowable cargo collapse amount X_{MAX} may be determined. In order to not exceed such a determined allowable cargo collapse amount X_{MAX}, an upper limit ω₀ of the yaw rate ω may be adapted to be set in the vicinity of 80°.

That is, the embodiment has described a case of determining the upper limit ω₀ of the yaw rate ω from the point of view of improvement in stability of the vehicle and reduction in user discomfort. However, from a different point of view, an upper limit ω₀ of the yaw rate may be grasped in a manner determined such that, when a certain cargo is supposed, the cargo does not collapse. That is, the cargo collapse may be suppressed using the traveling motor drive apparatus 100 according to the embodiment.

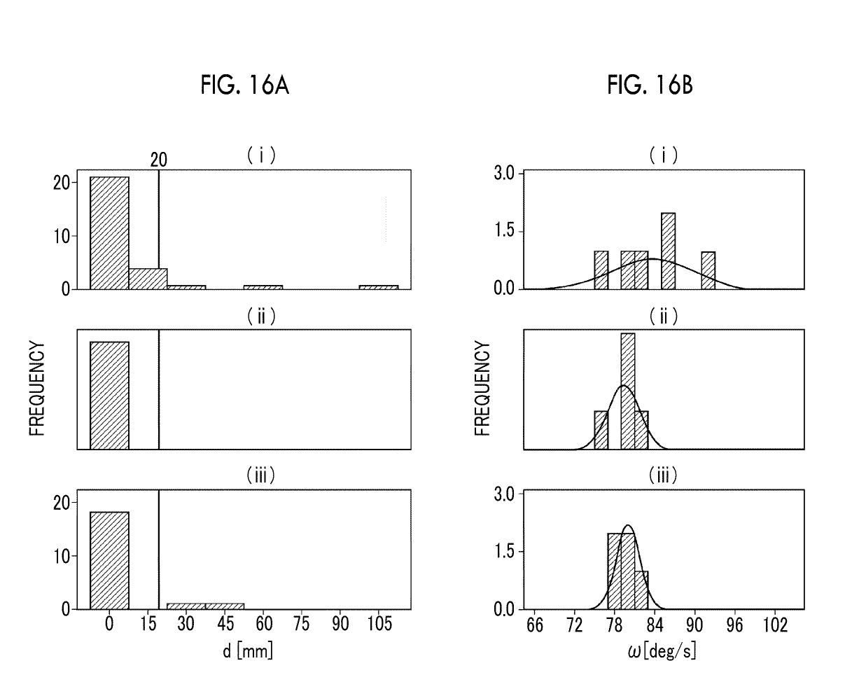

FIGS. 16A and 16B are frequency distribution charts of the cargo collapse amount d and the yaw rate w. FIGS. 16A and 16B are experimental results of a case in which the upper limit of the yaw rate ω is set, and then cargo is transported multiple times by the forklift. Here, (i) shows distribution in a case of not performing yaw rate control, (ii) shows distribution in a case of performing yaw rate control (speed limit) according to the embodiment, and (iii) shows distribution in a case of using yaw rate control and pitching control together.

The distribution of the yaw rate ω may be suppressed by performing the yaw rate control, as shown in FIG. 16B. In an example of FIG. 16B, it may be seen that a mean value of the distribution of the yaw rate is suppressed to be 80° or less. In addition, as shown in FIG. 16A, it may be seen that the distribution of the cargo collapse amount d is suppressed to be 20 mm or less and the cargo is prevented from falling.

In another embodiment, an accelerator operation amount by a driver may also be set, as it is, as a speed command value. In this case, a lateral G may be suppressed to be a constant K or less by controlling a turning radius R, and thus cargo may be prevented from collapsing.

In a further embodiment, K>R·ω² is maintained by controlling both of a turning radius R and a yaw rate ω, and thus a driver's operation feeling may be improved while cargo is prevented from collapsing.

The following technical sprit may be induced from the above description.

In a certain aspect, a forklift includes left and right traveling motors which transfer power to respective left and right drive wheels, a traveling motor drive apparatus which drives the left and right traveling motors, and a control unit in which a lateral G is controlled to be less than a predetermined constant by controlling at least one of a turning radius and a turning angular velocity (yaw rate) during turning.

The control unit may also be provided in a traveling motor drive apparatus 100 when the turning angular velocity is controlled, and may also be provided in a steering motor drive apparatus 104 when the turning radius is controlled. In addition, the control unit may also be provided in both of the traveling motor drive apparatus 100 and the steering motor drive apparatus 104.

The traveling motor drive apparatus may also be configured to be capable of suppressing vibration in a pitch direction by detecting rotation about a pitch axis and performing pitching control for suppressing pitching. The control unit may also control at least one of a turning radius R and a turning angular velocity ω in consideration of a static friction force applied to cargo, as the result of the pitching control.

The constant K may also be set as a value at which the cargo does not fall.

In the control unit, a map or function of the lateral G may also be stipulated based on the turning radius R and the turning angular velocity ω. In addition, the control unit may also stipulate a region in which cargo falls and a region in which cargo does not fall by the map or the function. The control unit may also be configured to correct an operation input, more specifically, a first control command value (a speed command value Vref) from an accelerator or a third control command value S3 from a handle so as to be normally operated in the region in which cargo does not fall, and to prevent the cargo from falling.

Furthermore, the region in which cargo falls and the region in which cargo does not fall may also be switched in a manual or automatic manner. The region in which cargo falls and the region in which cargo does not fall often have a different boundary, according to a used state of the forklift, a type and shape of transported cargo, a weight, a user's driving habit, or the like. According to this aspect, the forklift may be operated at an optimal parameter according to used situations.

Although the disclosure of the present invention has been described above based on the embodiments of the present invention, the disclosure is not limited thereto. It should be understood by those skilled in the art that various design modifications and modified examples may be made in the embodiments without departing from the principles and spirit of the disclosure. Hereinafter, the modified examples will be described.

Although the case in which the threshold value of the yaw rate is constant regardless of the turning angle δᵣ has been described in the embodiments, certain embodiments of the present invention are not limited thereto. For example, the threshold value of the yaw rate may also be determined according to the turning angle δᵣ. For example, the threshold value of the yaw rate may also increase as the absolute value of the turning angle δᵣ increases. On the contrary, the threshold value of the yaw rate may also decrease as the absolute value of the turning angle δᵣ increases.

Although the dual motor type forklift has been exemplarily described in the embodiments, certain embodiments of the present invention may also be applied to a single motor type forklift. Furthermore, certain embodiments of the present invention are not limited to the forklift, but are applicable to a variety of industrial vehicles having mechanisms similar thereto.

Certain embodiments of the present invention relate to a motor drive apparatus for forklifts.

It should be understood that the invention is not limited to the above-described embodiment, but may be modified into various forms on the basis of the spirit of the invention. Additionally, the modifications are included in the scope of the invention.

What is claimed is:

1. A motor drive apparatus, mounted to a forklift and controlling at least one motor that rotates a drive wheel of the forklift, based on a speed command value indicative of a target speed of the forklift, the motor drive apparatus comprising:
a turn speed limit unit in which a speed limit curve stipulating an upper limit value of a speed of the forklift is defined as a function of a turning angle of the forklift such that an angular velocity with respect to a center of rotation of the forklift does not exceed a threshold value, the turn speed limit unit being configured to limit the speed command value to be equal to or less than an upper limit value determined according to the speed limit curve and the turning angle; and
a drive unit that drives the at least one motor according to the speed command value.

2. The motor drive apparatus according to claim 1, further comprising a speed correction unit that corrects the speed command value according to a time differential value δ′ of the turning angle δ.

3. The motor drive apparatus according to claim 2, wherein the speed correction unit decreases the speed command value when an absolute value of the turning angle δ is increased, and increases the speed command value when the absolute value of the turning angle δ is decreased.

4. The motor drive apparatus according to claim 2, wherein when the speed limit curve is indicated by f(δ) as a function of the turning angle δ, the speed correction unit adds or subtracts a correction amount, which is proportional to df(δ)/dδ×δ′, to or from the speed command value.

5. The motor drive apparatus according to claim 4, wherein when a correction coefficient is set as Cg, the correction amount is Cg×df(δ)/dδ×δ′.

6. The motor drive apparatus according to claim 2, further comprising a lamp control unit that limits a change rate of the speed command value to be a certain value or less.

7. The motor drive apparatus according to claim 1, wherein the threshold value is determined as a value, at which cargo does not fall, under a predetermined traveling condition.

8. The motor drive apparatus according to claim 1, wherein the turning speed limit unit includes a low-pass filter that filters the speed command value output to the drive unit.

9. The motor drive apparatus according to claim 8, wherein the low-pass filter is configured such that a time constant thereof is switchable to at least two values.

10. The motor drive apparatus according to claim 9, wherein the time constant of the low-pass filter is set as a first value when the speed command value input to the drive unit is increased, and is set as a second value less than the first value when the speed command value input to the drive unit is decreased.

11. The motor drive apparatus according to claim 9, wherein the time constant of the low-pass filter is switched according to the speed command value output from the turning speed limit unit.

12. The motor drive apparatus according to claim 9, wherein the time constant of the low-pass filter is switched according to the turning angle.

13. The motor drive apparatus according to claim 1, wherein the threshold value is constant regardless of the turning angle.

14. The motor drive apparatus according to claim 1, wherein the threshold value is determined according to the turning angle.

15. A forklift comprising:
left and right drive wheels;
left and right traveling motors that transfer power to the respective left and right drive wheels; and
the motor drive apparatus according to claim 1, that drives the left and right traveling motors.

16. A forklift comprising:
left and right drive wheels;
left and right traveling motors that transfer power to the respective left and right drive wheels;
a traveling motor drive apparatus that drives the left and right traveling motors; and
a control unit that controls a lateral G to be less than a predetermined constant by controlling at least one of a turning radius and a turning angular velocity during turning.

17. The forklift according to claim 16, wherein:
the motor drive apparatus is configured to be capable of suppressing vibration in a pitch direction by pitching control; and
the control unit controls at least one of the turning radius and the turning angular velocity, in consideration of a static friction force applied to cargo, as the result of the pitching control.

18. The forklift according to claim 15, wherein the constant is set as a value at which cargo does not fall.

19. A forklift comprising:
left and right drive wheels;
left and right traveling motors that transfer power to the respective left and right drive wheels;
a traveling motor drive apparatus that drives the left and right traveling motors; and
a control unit in which a map or function of a lateral G is stipulated based on a turning radius and a turning angular velocity, the control unit being configured to allow a region in which cargo falls and a region in which cargo does not fall to be stipulated by the map or the function, to correct an operation input from a user so as to be normally operated in the region in which cargo does not fall, and to prevent cargo from falling.

20. The forklift according to claim 19, wherein the region in which cargo falls and the region in which cargo does not fall are switchable in a manual or automatic manner.
